(19) United States
(12) Patent Application Publication
(10) Pub. No.: US 2012/0200930 A1
(43) Pub. Date: Aug. 9, 2012

(54) LIGHT DIFFUSION SHEET, METHOD FOR PRODUCING LIGHT DIFFUSION SHEET, AND DISPLAY DEVICE

(76) Inventors: Emi Yamamoto, Osaka-shi (JP); Hidefumi Yoshida, Osaka-shi (JP)

(21) Appl. No.: 13/501,290

(22) PCT Filed: May 27, 2010
(86) PCT No.: PCT/JP2010/059019

§ 371 Date: Apr. 11, 2012

(30) Foreign Application Priority Data
Oct. 29, 2009 (JP) 2009-249286

(51) Int. Cl. G02B 5/02; B05D 3/06; C08J 3/28; B05D 5/06

(52) U.S. Cl. 359/599; 427/553; 522/100; 522/153

(57) ABSTRACT

A light diffusion sheet (1) includes: a light diffusion layer (2) including a transmitting section (2b) that transmits incident light from a light incidence plane and emits the light from a light exit plane, and grooves (2a) that are adjacent to the transmitting section (2b) at the light exit plane, and that contain wall surfaces either entirely reflecting or transmitting the incident light; light shielding sections (3a) that are provided on the light exit plane of the light diffusion layer (2) to face the grooves (2a) in such a manner as to seal the grooves (2a), and that absorb the light from the grooves (2a); and transmitting sections (3b) that are provided on the light exit plane to face the transmitting section (2b), and that transmit the light from the transmitting section (2b). This allows absorbing stray light, thereby preventing lowering of the frontal contrast and image blurring.

### TECHNICAL FIELD

The present invention relates to a light diffusion sheet most suitable for a display device such as a liquid crystal display device, a method for producing the light diffusion sheet, and a display device including the light diffusion sheet.

### BACKGROUND ART

Conventionally, a display device, such as a liquid crystal display device, utilizes a light diffusion sheet, which functions to increase a viewing angle, in order to enhance viewers' visibility. The light diffusion sheet is provided on the display device screen, and refracts light in many directions through a difference in refractive index. The light refracted by the light diffusion sheet is diffused from the surface of the light diffusion sheet into many directions and emitted to the viewers' side. This is how viewing a display device from a wide range of directions is achieved through utilizing a light diffusion sheet that diffuses light from the display device. However, although the light diffusion sheet enables viewers to view images of the display device from a wide range of directions by diffusing light from the display device, the light diffusion sheet causes such a problem that refracting of the light in many directions produces stray light that results in ghosting of the images, which causes image blurring.

A light diffusion sheet disclosed in the patent literature 1 is designed such that grooves having a V-shaped cross section provided in a light diffusion layer diffuse light and a light absorbing layer provided so as to seal the grooves absorbs stray light, thereby preventing deterioration in contrast of images. In the light diffusion sheet of the patent literature 1, all portions of the grooves except for the light absorbing layer are filled with air etc., which has lower refractive index than that of the light diffusion layer. In the light diffusion sheet of the patent literature 1, the light absorbing layer absorbs light that is incident to the walls of the grooves with large angles and that is transmitted through the walls toward a front direction.

Another example of the art that reduces the influence of stray light is a prism sheet disclosed in patent literature 2. The prism sheet has, at a light incidence plane of the base, a prism shape including a refractive plane that refracts light and a reflecting plane that entirely reflects the light. The prism sheet also includes, on a light exit plane positioned oppositely to the light incidence plane, a transmitting section that transmits the light and, a light shielding section that absorbs the light. In the patent literature 2, the light shielding section is formed in a striped pattern throughout the light exit plane so as to leave areas for transmitting the light that (i) enters the refractive plane from a light source, (ii) is refracted by the refractive plane, and (iii) is entirely reflected by the reflecting plane.

### CITATION LIST

### Patent Literature 1

Japanese Patent Application Publication, Tokukai, No. 2000-352608 (Publication Date: Dec. 19, 2000)

### Patent Literature 2

Japanese Patent Application Publication, Tokukai, No. 2006-119166 (Publication Date: May 11, 2006)

### SUMMARY OF INVENTION

### Technical Problem

Regarding the light diffusion sheet disclosed in the patent literature 1, the light absorbing layer is formed through squeezing low refractive index resin, by the force of a pressing roller, into the grooves formed on the light diffusion layer, and curing the low refractive index resin in the grooves. However, it is difficult to squeeze the low refractive index resin into the grooves in such a manner as to entirely seal the grooves, and to form the light absorbing layer with precision. This results in the presence of portions where the stray light cannot be adequately absorbed. This allows the light to escape, raising problems of lowering of the frontal contrast of the display device and of blurring images.

Further, regarding the prism sheet disclosed in the patent literature 2, the process of manufacturing the light shielding section is as follows: (i) a photosensitive layer whose adhesion becomes weakened by being exposed to light is formed on the light exit plane of the base, and portions of the photosensitive layer are irradiated with light from the light incidence plane so that the irradiated portions have reduced adhesion; (ii) a black colored layer is provided on the photosensitive layer; (iii) the portions of the colored layer corresponding to the portions of the photosensitive layer whose adhesion has been reduced are removed with a release layer; and (iv) the portions of the colored layer corresponding to the portions of the photosensitive layer whose adhesion has not been reduced remain by the adhesion of the photosensitive layer. Although the light shielding section is formed by its self-alignment through the radiating light as described above, it is difficult to accurately remove only the portions of the photosensitive layer whose adhesion has been reduced, and to leave only the light shielding section with precision. Besides, manufacturing the light shielding section requires gluing the photosensitive layer, the colored layer, and the release layer together precisely, and is complicated.

The present invention is invented in view of the above problems, and its object is to provide (i) a light diffusion sheet that prevents lowering of the frontal contrast and image blurring by absorbing stray light, and (ii) a method for producing the light diffusion sheet with ease.

### Solution to Problem

In order to solve the problems mentioned above, a light diffusion sheet of the present invention includes: a light diffusion layer including a first transmitting section that transmits incident light from a light incidence plane and emits the incident light from a light exit plane, and concave sections that are adjacent to the first transmitting section at the light exit plane, and that include wall surfaces either entirely reflecting or transmitting the incident light; and a light absorbing layer including light shielding sections that are provided on the light exit plane of the light diffusion layer to face the concave sections in such a manner as to seal the concave sections, and that absorb the incident light emitted from the light exit plane, and second transmitting sections that are provided on the light exit plane of the light diffusion layer to face the first transmitting section, and that transmit the incident light emitted from the light exit plane.

With the above configuration, the incident light that enters the light diffusion layer from the light incidence plane enters the wall surfaces of the concave sections, is entirely reflected and diffused, and is emitted from the light absorbing layer via the first transmitting section to the outside. This allows a user to view the display device from a wide range of directions. At that time, some light does not get reflected by the wall surfaces of the concave sections, is transmitted and refracted there, enters into the light absorbing layer through the concave sections, and becomes stray light. Emitting of this stray light would lead to lowering of the frontal contrast and to image blurring.

The light diffusion sheet of the present invention is designed such that the light shielding sections occupy portions of the light absorbing layer on the light diffusion layer to face the concave sections, and the second transmitting sections occupy other portions of the light absorbing layer. This allows reliably absorbing the stray light emitted from the concave sections and emitting (i) the light that is, without entering into the concave sections, transmitted by the first transmitting section, and (ii) the light that is entirely reflected by the concave sections and transmitted by the second transmitting sections. As described above, the light diffusion sheet of the present invention can reliably prevent stray light while providing plenty of light diffusion and enlarging the viewing angle by having the concave sections handle the diffusing of the light and having the light shielding sections handle the absorbing of the stray light. This allows preventing lowering of the frontal contrast and image blurring.

In order to solve the problems mentioned above, a method of the present invention for producing a light diffusion sheet is a method for producing one of the above light diffusion sheets, including: (i) a photochromic layer forming step of forming a photochromic layer made of a photochromic material having a photochromic characteristic that upon irradiation with predetermined light, the color of the photochromic material gets changed from a color that absorbs the incident light to a color that transmits the incident light; and (ii) an irradiation step of irradiating, from a light diffusion layer side, portions of the photochromic layer which face the first transmitting section with the predetermined light.

With the above configuration, the photochromic layer has the photochromic characteristic that, upon irradiation with predetermined light, the color of the photochromic material gets changed from a color that absorbs the incident light to a color that transmits the incident light, and the second transmitting sections are formed by irradiating portions of the photochromic layer which face the first transmitting section with the predetermined light so that the color of the irradiated portions gets changed to the color that transmits the incident light. The non-irradiated portions of the photochromic layer which face the concave portions retain the color that absorbs the incident light, and become the light shielding sections. In this way, the light shielding sections and the second transmitting sections can be easily and precisely formed through the self-aligning process that utilizes presence/absence of light paths through which portions of the photochromic layer are irradiated. Therefore, the light shielding sections do not allow an escape of the light, thereby preventing lowering of the frontal contrast and image blurring.

The transmitting display device of the present invention includes one of the above light diffusion sheets. This allows producing a display device that achieves a wide viewing angle while preventing the occurrence of stray light that causes lowering of the frontal contrast and image blurring.

### Advantageous Effects of Invention

A light diffusion sheet of the present invention includes: a light diffusion layer including a first transmitting section that transmits incident light from a light incidence plane and emits the incident light from a light exit plane, and concave sections that are adjacent to the first transmitting section at the light exit plane, and that include wall surfaces either entirely reflecting or transmitting the incident light; and a light absorbing layer including light shielding sections that are provided on the light exit plane of the light diffusion layer to face the concave sections in such a manner as to seal the concave sections, and that absorb the incident light emitted from the light exit plane, and second transmitting sections that are provided on the light exit plane of the light diffusion layer to face the first transmitting section, and that transmit the incident light emitted from the light exit plane. Therefore, the light diffusion sheet can reliably absorb stray light and prevent lowering of the frontal contrast and image blurring.

### BRIEF DESCRIPTION OF DRAWINGS

FIG. 1 is a cross-sectional view that schematically shows a light diffusion sheet in accordance with one embodiment of the present invention.

FIG. 2 is a cross-sectional view that describes the configuration of grooves of the light diffusion layer in accordance with one embodiment of the present invention.

FIG. 3 is a set of cross-sectional views, (a) and (b), showing one embodiment of a method for producing the light diffusion sheet as shown in FIG. 1.

FIG. 4 is a top view that schematically shows a light diffusion sheet in accordance with another embodiment of the present invention.

### DESCRIPTION OF EMBODIMENTS

### Embodiment 1

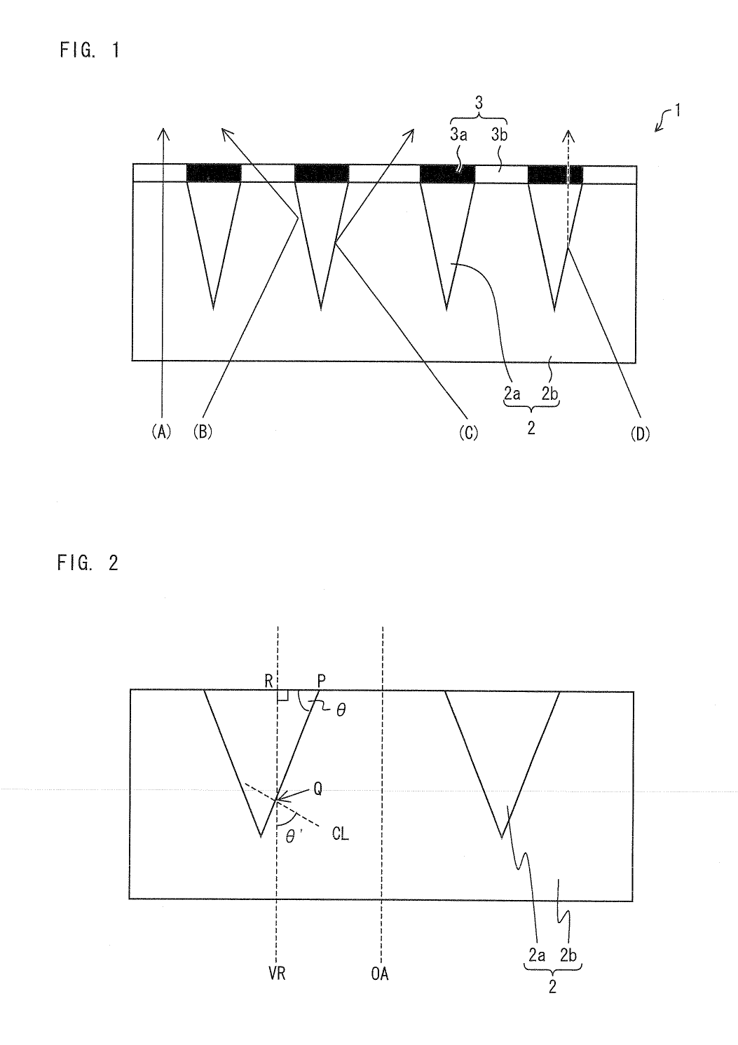

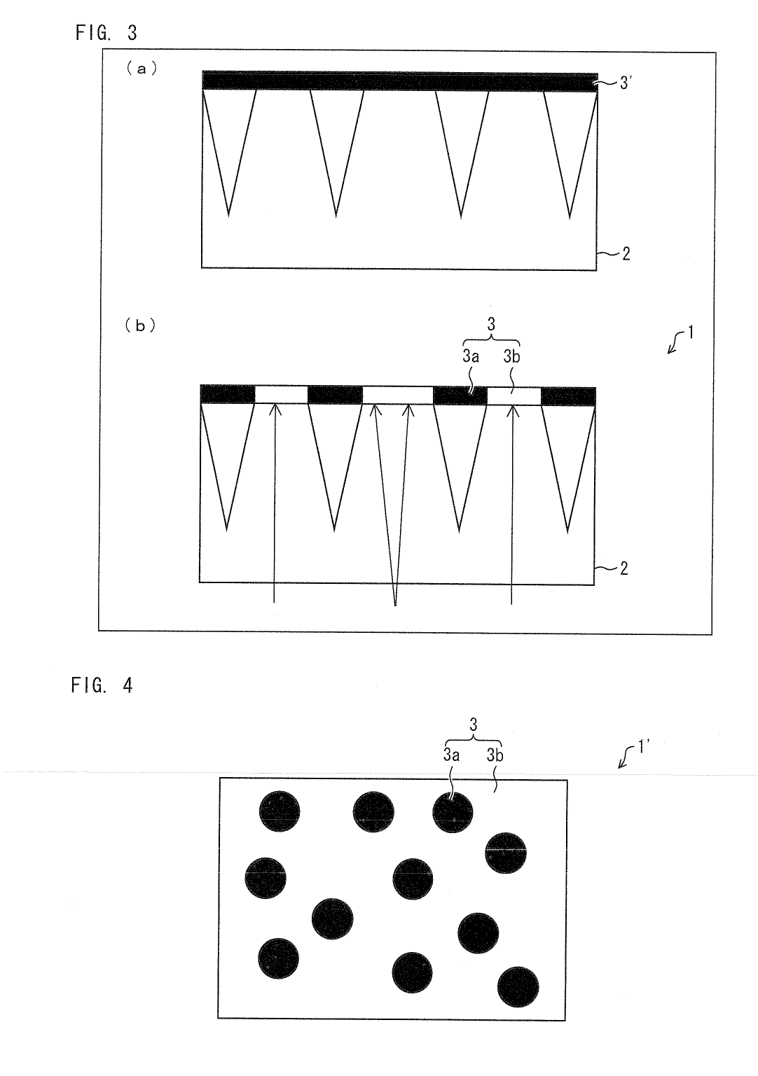

The embodiment 1 of the present invention is described below with reference to FIG. 1 through FIG. 3. FIG. 1 is a cross-sectional view that schematically shows a light diffusion sheet 1 in accordance with one embodiment of the present invention. FIG. 2 is a cross-sectional view to describe the configuration of grooves 2a of a light diffusion layer 2 in the light diffusion sheet 1. (a) and (b) of FIG. 3 are cross-sectional views that show one embodiment of a method for producing the light diffusion sheet 1 shown in FIG. 1. As shown in FIG. 1, the light diffusion sheet 1 of the present invention includes the light diffusion layer 2 and a light absorbing layer 3 which is provided on the light diffusion layer 2. Also, the light diffusion layer 2 is constituted by the grooves (concave sections) 2a and a transmitting section (first transmitting section) 2b, and the light absorbing layer 3 is constituted by light shielding sections 3a and transmitting sections (second transmitting sections) 3b.

In a transmitting display device such as a liquid crystal display device, the light diffusion sheet 1 is to be provided on a front of a display panel. The light diffusion sheet 1 diffuses light which is radiated from a backlight to the display panel and emitted towards the viewers' side, thereby enlarging the viewing angle. When providing the light diffusion sheet 1 on the transmitting display device, there is an option to supply, between a light source and the light diffusion sheet 1, a linear film positioned like a blind curtain, called a louver, and to design the light source to emit collimated (or roughly collimated) light. The light diffusion sheet is to be provided so as to have the light diffusion layer 2 face the backlight from which the light enters.

The light diffusion layer 2 includes a light incidence plane at the bottom and a light exit plane at the top as shown in FIG. 1. The light diffusion layer 2 transmits incident light, which enters from the light incidence plane, to the light exit plane through the transmitting section 2b, and emits the light to the light absorbing layer 3 from the light exit plane. It is desirable that the light diffusion layer 2 be made of a material capable of transmitting the incident light. Considering the transmittance, it is desirable that the light diffusion layer 2 be made of transparent resin. Such a material for the light diffusion layer 2 includes, but is not limited to, transparent resin such as epoxy acrylate, vinyl chloride resin, styrene resin, urethane resin, polyester resin, acrylic resin, and polycarbonate resin etc.

The light diffusion layer 2 includes, at the light exit plane, the grooves 2a that are concaved in a direction towards the light incidence plane. In the present embodiment, the grooves 2a are provided so as to have a substantially V-shaped cross section tapering towards the light incidence plane when is the grooves 2a are cut in a thickness direction of the light diffusion layer 2. The grooves 2a are, when viewing the light diffusion sheet 1 from a top, formed in such a manner that the grooves 2a and the transmitting section 2b are positioned adjacently and alternately to form stripes. The boundary surfaces between the grooves 2a and the transmitting section 2b are wall surfaces that either transmit or entirely reflect the incident light by the difference in refractive index between the grooves 2a and the transmitting section 2b. That is to say, in the present embodiment, each of the grooves 2a is configured to have a V-shaped cross section defined by two wall surfaces. These wall surfaces can be either flat or curved.

The grooves 2a may be filled with a material that has lower refractive index than that of the transmitting section 2b, or may be filled with air by providing the light absorbing layer 3 while the grooves are kept void. Utilizing air to fill the grooves 2a to cause a difference in refractive index from the transmitting section 2b is more desirable than utilizing costly materials with low refractive index. The grooves 2a should be configured to either entirely reflect or transmit and refract the incident light that enters the wall surfaces of the grooves 2a by the difference in refractive index between the grooves 2a and the transmitting section 2b. The material that has lower refractive index than that of the transmitting section 2b and is to fill the groves 2a includes, but is not limited to, acrylic resin, epoxy resin, polycarbonate resin, polyester resin, and acrylate resin containing silicon and fluorine etc.

The angle of each wall surface to the light exit plane is not particularly limited as long as the angle allows plenty of light diffusion. The angle of the grooves 2a to the light diffusion layer 2 is described below with reference to FIG. 2. For convenience of explanation, FIG. 2 only illustrates the light diffusion layer 2. As shown in FIG. 2, the angle e between (i) the inclined plane being the boundary surface between each of the grooves 2a and the transmitting section 2b and (ii) the light exit plane is set to the angle θ′ (the unit is degree °]) that is greater than the critical angle of the grooves 2a to the normal line CL so as to entirely reflect the incident light parallel or roughly parallel to the light axis OA.

Assume that (i) a point where the inclined plane of the groove 2a crosses the light exit plane is a point P, (ii) an incidence point where incident light VR parallel to a light axis OA enters the groove 2a is a point Q, and (iii) an intersecting point where a line which is normal to the light exit plane and which runs through the point Q crosses the light exit plane is a point R. At that time, the angle θ can be represented as an angle QPR. Here, since the value of an angle PQR is (90-θ)°, the angle of inclination θ of the grooves 2a is equal to the angle of incidence θ′ of the incident light VR at the point Q. Therefore, the angle of inclination θ of the grooves 2a is formed by the angle greater than the critical angle.

The incident light that enters the grooves 2a with the angle greater than the critical angle is entirely reflected, is transmitted through the transmitting section 2b, and enters the transmitting sections 3b as shown by the arrow (B) and (C) of FIG. 1. Also, the incident light, which does not enter the grooves 2a and is transmitted between the grooves 2a, directly enters the transmitting sections 3b through the transmitting section 2b as shown by the arrow (A).

On the other hand, the incident light, which enters the grooves 2a with the angle less than the critical angle, is not entirely reflected by the wall surfaces, and enters the light shielding sections 3a from the grooves 2a as shown by the dotted arrow (D). If this light that enters the light shielding sections 3a from the grooves 2a would be seen by the viewers, the frontal contrast would be lowered and image blurring would occur. The light diffusion sheet 1 is designed such that the light that enters the light absorbing layer 3 from the grooves 2a is absorbed by the light shielding sections 3a so as to prevent the occurrence of the stray light. This prevents the occurrence of lowering of the frontal contrast and image blurring.

The method for producing the grooves 2a in the light diffusion layer 2 is not particularly limited. One example of the method is subjecting resin which is the material for the light diffusion layer 2 to press molding, injection molding etc. with a mold having convexities shaped inversely to the grooves 2a, and thereafter curing the molded resin.

The light absorbing layer 3 is provided on the light exit plane of the light diffusion layer 2. The light shielding sections 3a are positioned to face the grooves 2a of the light diffusion layer 2, and the transmitting sections 3b are positioned to face the transmitting section 2b. The light shielding sections 3a are provided so as to seal the grooves 2a, and absorb the incident light emitted from the grooves 2a. The transmitting sections 3b transmit the incident light emitted from the light diffusion layer 2 through the transmitting section 2b, and emit the incident light to the outside (viewers' side).

It is desirable that the light shielding sections 3a be black, which is high in OD value, in order to reliably absorb the stray light emitted from the grooves 2a, and that the transmitting sections 3b be transparent in order to transmit the light from the transmitting section 2b of the light diffusion layer 2. In order to form the light shielding sections 3a and the transmitting sections 3b as described above with ease and certainty, the light diffusion layer 3 is to be made of a photochromic material having the photochromic characteristic which is a change from a color that absorbs incident light to a color that transmits the incident light upon irradiation with predetermined light.

The photochromic material contains a photochromic compound that has a characteristic that a single chemical species reversibly isomerizes, by an effect of light, between two states of different absorbing spectrums without changing its molecular weight. That is, irradiating the photochromic compound with light having a predetermined wavelength changes the states of the chemical species by the energy of the light, and the spectral absorption band changes accordingly. Then, move of the spectral absorption band to a visible light spectrum changes the color.

The method for producing the light diffusion sheet 1 including the light absorbing layer 3 made of such a photochromic material is described below with reference to (a) and (b) of FIG. 3. As shown in (a) of FIG. 3, the first step is to form a photochromic layer 3′ made of the photochromic material on the light diffusion layer 2 including the grooves 2a formed by press molding etc. in such a manner that the photochromic layer 3′ covers the light exit plane of the light diffusion layer 2 (the photochromic layer forming step).

The photochromic material used here has the photochromic characteristic of changing from black to be transparent upon irradiation with predetermined light, such as ultraviolet. Such a photochromic material includes, but is not limited to, black light-sensitive resin of positive type (the color of the section exposed to light disappears).

Next, as shown in (b) of FIG. 3, only portions of the photochromic layer 3′ which portions face the transmitting section 2b are irradiated with light having a predetermined wavelength from the light incidence plane side of the light diffusion layer 2 (irradiation step). At this point, a light source for emitting collimating light is used to emit the predetermined light, so that only portions of the photochromic layer 3° which portions face the transmitting section 2b are irradiated with the predetermined light. As described above, by radiating the light having a predetermined wavelength, the portions of the photochromic layer 3′ which are irradiated with the light become the transparent transmitting sections 3b, and the portions not irradiated with the light remain black without any color change and become the light shielding sections 3a. This is how the light absorbing layer 3 is formed.

As described above, the light shielding sections 3a and the transmitting sections 3b are formed through the self-aligning process that utilizes presence/absence of light paths through which portions of the photochromic layer 3′ are irradiated. This makes it possible to form the light shielding sections 3a and the transmitting sections 3b with ease and precision without requiring precise positioning as in the case of masking. Therefore, an escape of the light from the light shielding sections 3a does not occur, thereby preventing lowering of the frontal contrast and image blurring.

In addition, the photochromic layer 3′ in which the light shielding sections 3a and the transmitting sections 3b are formed by irradiation with the predetermined light in the irradiation step may be arranged such that the color is fixed so as to make the transparency of the transmitting sections 3b permanent (fixing step). The fixing of the color can be done through treating the photochromic layer with heat or light. Fixing of the color can prevent (i) the color from changing back to the previous color when the radiation of the light ceases, and (ii) some portions from further changing the color when additional light is radiated. Therefore, when actually utilizing the light diffusion sheet 1 attached to an image display device, the color of the light diffusion layer 3 does not get changed by the light from the display device.

Besides, even more options are to utilize (i) a photochromic material that contains a characteristic that the color of the material gets changed only by a certain type of light, and not by the natural sunlight etc., and (ii) a photochromic material that has irreversibility (the once-changed color does not change back). In this way, production of the light diffusion sheet 1 can be done without the fixing step mentioned above.

As described above, the light diffusion sheet 1 can make separation between the sections to diffuse light and the sections to absorb stray light, by including, on the light diffusion layer 2, the light absorbing layer 3 that includes (i) the transmitting sections 3b that transmit the light entirely reflected by the grooves 2a and emit the light to the viewers' side, and (ii) the light shielding sections 3a that absorb the light that is refracted, and not entirely reflected, by the grooves 2a and is emitted from the grooves 2a. Thus, it is possible to form the light shielding sections 3a with a material high in OD value, which prevents an escape of the light, regardless of the refractive index for entire refraction of the light. As a result, the light shielding sections do not allow the escape of the light, and prevent lowering of the frontal contrast and image blurring. Also, the tone of the color does not change depending on the change in the viewers' visual perception.

In Addition, since the photochromic material is used, the light shielding sections 3a and the transmitting sections 3b can be formed through the self-aligning process that utilizes presence/absence of light paths through which portions of the photochromic material are irradiated. This makes it possible to more easily and precisely form the light shielding sections 3a and the transmitting sections 3b without preparing a special manufacturing apparatus.

### Embodiment 2

An embodiment 2 of the present invention is described below with reference to FIG. 4. FIG. 4 is a top view that schematically shows a light diffusion sheet 1′ in accordance with another embodiment of the present invention. The light diffusion sheet 1′ in accordance with the present embodiment is different from the light diffusion sheet 1 in accordance with the embodiment 1 in that the grooves 2a in the light diffusion sheet 1′ have a conical solid shape tapering towards the light incidence plane, and are provided in a random order. In the present embodiment, the points that distinguish the present embodiment from the embodiment 1 are described, and the other details are omitted.

As shown in FIG. 4, in the light diffusion sheet 1′, the grooves 2a provided to face the light shielding sections 3a are positioned randomly in the light diffusion layer 2 while keeping certain space from each other. Here, the grooves 2a have a conical solid shape, such as a cone and a square pyramid, tapering towards the light incidence plane so as to diffuse light into at least four directions, rightward, leftward, upward, and downward, and have a substantially V-shaped cross section when the grooves 2a are cut in a thickness direction of the light diffusion layer 2.

Just as the embodiment 1, the light absorbing layer 3 is provided on the light diffusion layer 2 that includes the grooves 2a as described above. As shown in FIG. 4, the portions of the light absorbing layer 3 which face the grooves 2a serve as the light shielding sections 3a, and the rest of the light absorbing layer 3 serve as the transmitting sections 3b. When utilizing the light diffusion sheet that contains periodic patterns arranged linearly, severe moirés occur between the periodic patterns of a liquid crystal panel and the periodic patterns of the light diffusion sheet. However, providing the grooves 2a in random positions can prevent the occurrence of moirés, thereby achieving a wide viewing angle.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

Also, it is desirable to arrange the light diffusion sheet of the present invention such that the light absorbing layer be made of a photochromic material having a photochromic characteristic that, upon irradiation with predetermined light, the color of the photochromic material gets changed from a color that absorbs the incident light to a color that transmits the incident light, and the second transmitting sections be made of portions of the photochromic material which have been irradiated with the predetermined light, and the light shielding sections be made of portions of the photochromic material which have not been irradiated with the predetermined light.

The above arrangement utilizes the light absorbing layer that includes the light shielding sections and the second transmitting sections, which are formed only by irradiating the photochromic material with the predetermined light and through the self-aligning process that utilizes presence/absence of light paths through which portions of the photochromic material are irradiated. Therefore, the light shielding sections and the second transmitting sections can be easily and precisely formed by determining the light paths of the radiating light without precise positioning as in a case of masking. Therefore, the light shielding sections prevent an escape of the light, thereby preventing lowering of the frontal contrast and image blurring.

In addition, it is desirable to arrange the light diffusion sheet of the present invention such that the concave sections have a substantially V-shaped cross section tapering towards the light incidence plane when the concave sections are cut in a thickness direction of the light diffusion layer. It is also desirable to arrange the light diffusion sheet of the present invention such that the concave sections have a conical solid shape tapering towards the light incidence plane. This arrangement allows only a single light diffusion sheet to effectively diffuse the light, thereby achieving a wide viewing angle.

Besides, it is desirable to arrange the method of the present invention to further include a fixing step of fixing the color of the portions of the photochromic layer which have been irradiated with the predetermined light in the irradiation step. This arrangement allows stabilizing the light shielding sections and the second transmitting sections after being formed, thereby achieving steady light diffusion and absorption of stray light by the light diffusion sheet.

### INDUSTRIAL APPLICABILITY

The present invention is applicable to a display device such as a liquid crystal display device, and to a light diffusion sheet that enlarges a viewing angle of the display device.

### REFERENCE SIGNS LIST

1, 1′ Light diffusion sheet

2 Light diffusion layer

2a Grooves (Concave sections)

2b Transmitting section (First transmitting section)

3 Light absorbing layer

3a Light shielding section

3b Transmitting sections (Second transmitting sections)

1. A light diffusion sheet comprising:
a light diffusion layer including
a first transmitting section that transmits incident light from a light incidence plane and emits the incident light from a light exit plane, and
concave sections that are adjacent to the first transmitting section at the light exit plane, and that include wall surfaces reflecting, totally reflecting or transmitting the incident light; and
a light absorbing layer including
light shielding sections that are provided on the light exit plane of the light diffusion layer to face the concave sections in such a manner as to be located in accordance with the concave sections, and that absorb the incident light emitted from the light exit plane, and
second transmitting sections that are provided on the light exit plane of the light diffusion layer to face the first transmitting section, and that transmit the incident light emitted from the light exit plane.

2. The light diffusion sheet as set forth in claim 1, wherein
the light absorbing layer is made of a photochromic material having a photochromic characteristic that upon irradiation with predetermined light, the color of the photochromic material gets changed from a color that absorbs the incident light to a color that transmits the incident light, and
the second transmitting sections are made of portions of the photochromic material which have been irradiated with the predetermined light, and the light shielding sections are made of portions of the photochromic material which have not been irradiated with the predetermined light.

3. The light diffusion sheet as set forth in claim 1, wherein the concave sections have a substantially V-shaped cross section tapering towards the light incidence plane when the concave sections are cut in a thickness direction of the light diffusion layer.

4. The light diffusion sheet as set forth in claim 3, wherein the concave sections have a conical solid shape tapering towards the light incidence plane.

5. A method for producing a light diffusion sheet as set forth in claim 1, comprising:
a photochromic layer forming step of forming a photochromic layer made of a photochromic material having a photochromic characteristic that upon irradiation with predetermined light, the color of the photochromic material gets changed from a color that absorbs the incident light to a color that transmits the incident light; and
an irradiation step of irradiating, from a light diffusion layer side, portions of the photochromic layer which face the first transmitting section with the predetermined light.

6. The method as set forth in claim 5, further comprising a fixing step of fixing the color of the portions of the photochromic layer which have been irradiated with the predetermined light in the irradiation step.

7. A transmitting display device comprising a light diffusion sheet as set forth in claim 1.

8. The light diffusion sheet as set forth in claim 1, wherein the first transmitting section is made of resin.

9. The light diffusion sheet as set forth in claim 8, wherein the resin is made of acrylate.

10. A method for producing a light diffusion sheet as set forth in claim 1, comprising:
forming the light shielding sections; and
forming the first transmitting section,
wherein a position of each of the second transmitting sections of the light absorbing layer and a position of the first transmitting section of the light diffusion layer are identical with each other on the light exit plane of the light diffusion layer, the light shielding sections and the second transmitting sections being fabricated through a self-alignment fabrication process that utilizes light paths between the light diffusion layer and the light absorbing layer.

11. The method as set forth in claim 10, wherein the self-alignment fabrication process utilizes light paths coming through the light diffusion layer toward the light absorbing layer.

12. The method as set forth in claim 10, wherein a photosensitive layer is utilized for the self-alignment fabrication process.

13. The method as set forth in claim 12, wherein the photosensitive layer is irradiated with light coming through the first light transmitting section.

14. The method as set forth in claim 12, wherein the photosensitive layer is made of resin or a photochromic material.

15. The method as set forth in claim 14, wherein the resin is photo reactive resin.

16. The method as set forth in claim 15, wherein the photo reactive resin is acrylate or epoxy acrylate.

17. The method as set forth in claim 10, wherein the concave sections have a substantially V-shaped cross section tapering towards the light incidence plane when the concave sections are cut in a thickness direction of the light diffusion layer.

18. The method as set forth in claim 10, wherein the concave sections have a conical solid shape tapering towards the light incidence plane.
